(19) United States
(12) Patent Application Publication
(10) Pub. No.: US 2018/0056593 A1
(43) Pub. Date: Mar. 1, 2018

(54) THREE-DIMENSIONAL OBJECT, THREE-DIMENSIONAL OBJECT MANUFACTURING METHOD, AND 3D DATA GENERATION PROGRAM

(71) Applicant: MIMAKI ENGINEERING CO., LTD., NAGANO (JP)

(72) Inventors: Kazuhiro Ochi, Nagano (JP); Masakatsu Okawa, Nagano (JP)

(73) Assignee: MIMAKI ENGINEERING CO., LTD., NAGANO (JP)

(21) Appl. No.: 15/691,752

(22) Filed: Aug. 31, 2017

(30) Foreign Application Priority Data
Aug. 31, 2016 (JP) 2016-169354

(51) Int. Cl. B29C 64/393; G05B 19/4099; B29C 64/40; B33Y 10/00; B33Y 50/02; B33Y 80/00

(52) U.S. Cl. CPC B29C 64/393; G05B 19/4099; B29C 64/40; B33Y 10/00; B29L 2031/722; B33Y 80/00; G05B 2219/35134; G05B 2219/49007; B33Y 50/02

(57) ABSTRACT

To provide a three-dimensional object, a three-dimensional object manufacturing method, and a 3D data generation program that can facilitate handling compared to the conventional art even if the object is large. A three-dimensional object includes: a shell portion internally formed with a cavity; and a filling material that is filled in the cavity, and the filling material has a smaller specific gravity than the shell portion. The shell portion is configured by a plurality of parts, and the shell portion is formed with a filling material introducing port for introducing the filling material into the cavity when filling the filling material into the cavity, and a gas discharging port for discharging gas in the cavity to outside the cavity when filling the filling material into the cavity.

### CROSS REFERENCE TO RELATED APPLICATIONS

This application claims the priority benefit of Japanese Patent Application No. 2016-169354, filed on Aug. 31, 2016. The entirety of the above-mentioned patent application is hereby incorporated by reference herein and made a part of this specification.

### TECHNICAL FIELD

The present disclosure relates to a three-dimensional object, which is a stereoscopically shaped object, a three-dimensional object manufacturing method, and a 3D data generation program.

### DESCRIPTION OF THE BACKGROUND ART

A full scale bust, and the like is known for the conventional three-dimensional object (see e.g., Japanese Unexamined Patent Publication No. 2003-196486).

Patent Literature 1: Japanese Unexamined Patent Publication No. 2003-196486

### SUMMARY

However, if the three-dimensional object is a large object such as a full scale model of an object having a size of greater than or equal to a human, the three-dimensional object becomes heavy and becomes difficult to handle when being conveyed and installed.

The present disclosure provides a three-dimensional object, a three-dimensional object manufacturing method, and a non-transitory computer readable medium stored with a 3D data generation program that can facilitate handling compared to the conventional art even if the object is large.

A three-dimensional object of the present disclosure includes: a shell portion internally formed with a cavity; and a filling material that is filled in the cavity, the filling material having a smaller specific gravity than the shell portion.

According to such a configuration, the three-dimensional object of the present disclosure becomes lighter as the filling material, having smaller specific gravity than the shell portion, is filled into the cavity of the shell portion, whereby handling when being conveyed and installed can be more facilitated than the conventional art even if the object is large.

In the three-dimensional object of the present disclosure, the shell portion may be configured by a plurality of parts.

According to such a configuration, the three-dimensional object of the present disclosure can be subdivided by being divided into the plurality of parts, and thus the handling when being conveyed and installed can be facilitated even if the object is large.

In the three-dimensional object of the present disclosure, the shell portion may be formed with a filling material introducing port for introducing the filling material into the cavity when filling the filling material into the cavity, and a gas discharging port for discharging gas in the cavity to outside the cavity when filling the filling material into the cavity.

According to such a configuration, the three-dimensional object of the present disclosure can facilitate the handling when being conveyed and installed even if the object is large since the shell portion is conveyed in a state where the filling material is not filled in the cavity of the shell portion, and after the shell portion is conveyed, the filling material is introduced into the cavity of the shell portion from the filling material introducing port of the shell portion.

In the three-dimensional object of the present disclosure, the shell portion may be formed with a support material discharging port for discharging a support material that supports at least one part of the shell portion from the cavity when the shell portion is shaped, and the support material discharging port may be at least one of the filling material introducing port and the gas discharging port.

According to such a configuration, the three-dimensional object of the present disclosure can simplify the configuration as the support material discharging port also acts as at least one of the filling material introducing port and the gas discharging port.

A three-dimensional object manufacturing method of the present disclosure is a three-dimensional object manufacturing method for manufacturing the three-dimensional object described above, where the shell portion is conveyed in a state where the filling material is not filled in the cavity, and after the shell portion is conveyed, the filling material is introduced into the cavity from the filling material introducing port.

According to such a configuration, the three-dimensional object manufacturing method of the present disclosure can facilitate the handling when being conveyed and installed even if the three-dimensional object is large since the shell portion is conveyed in a state where the filling material is not filled in the cavity of the shell portion, and after the shell portion is conveyed, the filling material is introduced into the cavity of the shell portion from the filling material introducing port of the shell portion.

A non-transitory computer readable medium stored with a 3D data generation program of the present disclosure has a 3D data generation program for generating 3D data of the shell portion of the three-dimensional object described above, where the 3D data generation program causes a computer to realize a 3D data generator for generating the 3D data of the shell portion, and a filling material necessary amount notifier for notifying a necessary amount of the filling material, and the filling material necessary amount notifier calculates the necessary amount of the filling material based on a volume of the cavity.

According to such a configuration, the computer that executes the 3D data generation program of the present disclosure notifies the necessary amount of the filling material, so that a person who introduces the filling material into the cavity of the shell portion from the filling material introducing port of the shell portion can prepare the appropriate amount of filling material, thus enhancing convenience.

A non-transitory computer readable medium stored with a 3D data generation program of the present disclosure has a 3D data generation program for generating 3D data of the shell portion of the three-dimensional object described above, where the 3D data generation program causes a computer to realize a 3D data generator for generating the 3D data, and the 3D data generator specifies an area where the filling material is not reached in the cavity when the filling material is introduced into the cavity from the filling material introducing port, and changes the 3D data with the area which is specified as one part of the shell portion.

According to such a configuration, the computer that executes the 3D data generation program of the present disclosure generates the 3D data of the shell portion so that the filling material can spread throughout the cavity of the shell portion when the filling material is introduced into the cavity of the shell portion from the filling material introducing port, and thus can enhance the quality of the three-dimensional object to be manufactured.

A non-transitory computer readable medium stored with a 3D data generation program of the present disclosure has a 3D data generation program for generating 3D data of the shell portion of the three-dimensional object described above, where the 3D data generation program causes a computer to realize a 3D data generator for generating the 3D data, and the 3D data generator specifies an area where the filling material is not reached in the cavity when the filling material is introduced into the cavity from the filling material introducing port, and changes the 3D data to a configuration of the filling material introducing port that allows the filling material to reach the area which is specified.

According to such a configuration, the computer that executes the 3D data generation program of the present disclosure generates the 3D data of the shell portion so that the filling material can spread throughout the cavity of the shell portion when the filling material is introduced into the cavity of the shell portion from the filling material introducing port, and thus can enhance the quality of the three-dimensional object to be manufactured.

A three-dimensional object, a three-dimensional object manufacturing method, and a non-transitory computer readable medium stored with a 3D data generation program of the present disclosure can facilitate handling compared to the conventional art even if the object is large.

### BRIEF DESCRIPTION OF THE DRAWINGS

FIG. 1 is a front view of a three-dimensional object according to one embodiment of the present disclosure.

FIG. 2 is a front cross-sectional view of the three-dimensional object shown in FIG. 1.

FIG. 3A is a front cross-sectional view of a fit-in portion of a joining portion of parts in the three-dimensional object shown in FIG. 1.

FIG. 3B is a front cross-sectional view of a pin of the joining portion of the parts in the three-dimensional object shown in FIG. 1.

FIG. 4 is a front cross-sectional view of a shell portion of a right leg portion shown in FIG. 1.

FIG. 5 is a block diagram of a 3D data generation system for generating 3D data of the shell portion of the three-dimensional object shown in FIG. 1.

FIG. 6 is a block diagram of a computer shown in FIG. 5.

FIG. 7 is a front view of a 3D printer for manufacturing the shell portion of the three-dimensional object shown in FIG. 1.

FIG. 8 is a block diagram of the 3D printer shown in FIG. 7.

FIG. 9 is a front cross-sectional view of each part of the shell portion of the right leg portion shown in FIG. 4.

FIG. 10 is a front cross-sectional view of the shell portion of the right leg portion shown in FIG. 9 in a state where the parts are combined.

FIG. 11 is a front cross-sectional view of the shell portion of the right leg portion shown in FIG. 10 in a state where the filling material is introduced into the cavity.

FIG. 12 is a front cross-sectional view of the right leg portion shown in FIG. 2 before a lid is attached.

FIG. 13 is a front cross-sectional view of the right leg portion shown in FIG. 2.

### DETAILED DESCRIPTION OF EMBODIMENTS

One embodiment of the present disclosure will be hereinafter described using the drawings.

First, a configuration of a three-dimensional object according to the present embodiment will be described.

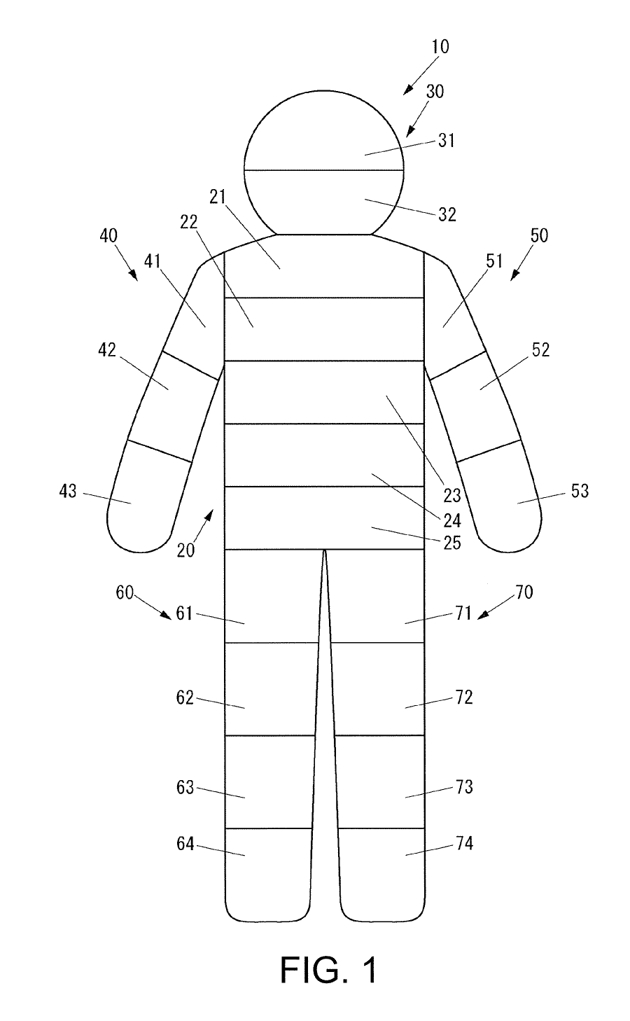

FIG. 1 is a front view of a three-dimensional object 10 according to the present embodiment.

As shown in FIG. 1, the three-dimensional object 10 is a full scale model of a human.

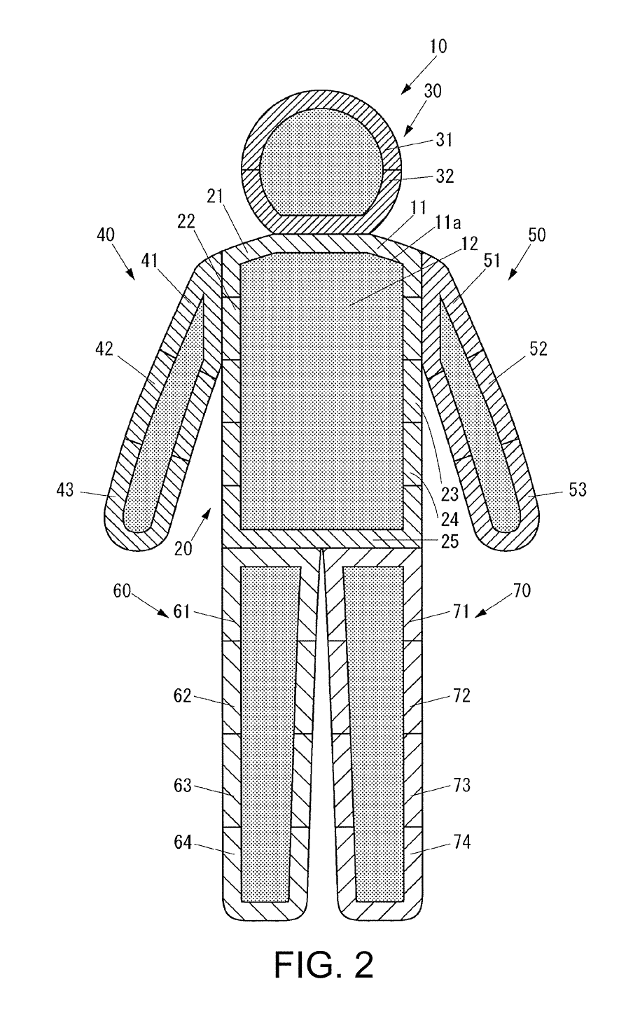

FIG. 2 is a front cross-sectional view of the three-dimensional object 10.

As shown in FIG. 2, the three-dimensional object 10 includes a shell portion 11 internally formed with a cavity 11a, and a filling material 12 that is filled into the cavity 11a, and the filling material 12 has a smaller specific gravity than the shell portion 11.

The filling material 12 is configured by urethane foam in which urethane resin is added with a foaming agent and foamed. The urethane foam is used in the present embodiment for the filling material 12, but a foaming type filling material other than the urethane foam may be used or a non-foaming type filling material may be used.

The three-dimensional object 10 includes a body portion 20, a head portion 30, a right arm portion 40, a left arm portion 50, a right leg portion 60, and a left leg portion 70. Each of the body portion 20, the head portion 30, the right arm portion 40, the left arm portion 50, the right leg portion 60, and the left leg portion 70 includes one part of the shell portion 11 and one part of the filling material 12.

The shell portion 11 of the body portion 20 is configured by parts 21, 22, 23, 24, and 25.

The shell portion 11 of the head portion 30 is configured by parts 31 and 32.

The shell portion 11 of the right arm portion 40 is configured by parts 41, 42, and 43.

The shell portion 11 of the left arm portion 50 is configured by parts 51, 52, and 53.

The shell portion 11 of the right leg portion 60 is configured by parts 61, 62, 63 and 64.

The shell portion 11 of the left leg portion 70 is configured by parts 71, 72, 73, and 74.

A joining portion of the parts such as a joining portion of the body portion 20, the head portion 30, the right arm portion 40, the left arm portion 50, the right leg portion 60, and the left leg portion 70 is preferably formed in an area that is less likely to stand out in terms of design in the three-dimensional object 10.

An adhesive may be used to join the parts.

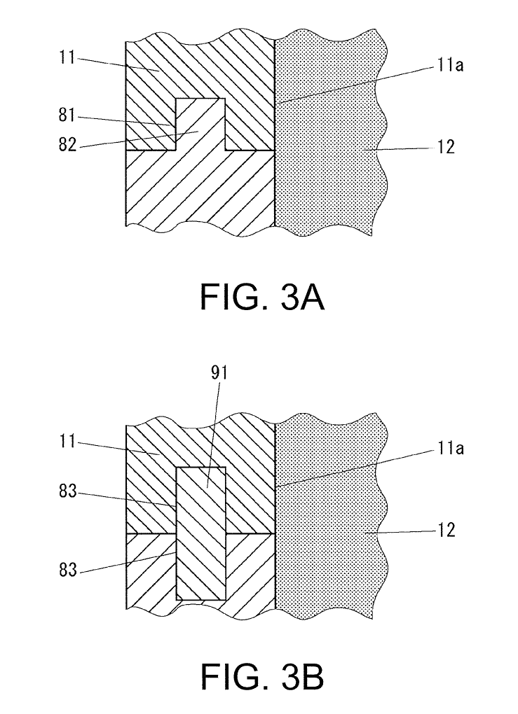

FIG. 3A is a front cross-sectional view of a fit-in portion 81 and a fit-in portion 82 of the joining portion of the parts. FIG. 3B is a front cross-sectional view of a pin 91 of the joining portion of the parts.

The joining portion of the parts may be formed by a plane, but as shown in FIG. 3A, the fit-in portion 81 and the fit-in portion 82 in a concave and convex form may be formed in each part, or a recess 83, to which the pin 91 that is a separate member from each part is inserted, may be formed in each part.

In each part, the joining portion with another part preferably has a thick thickness compared to the portions other than the joining portion to enhance the easiness of the joining work with the other parts and the strength of joining with the other parts.

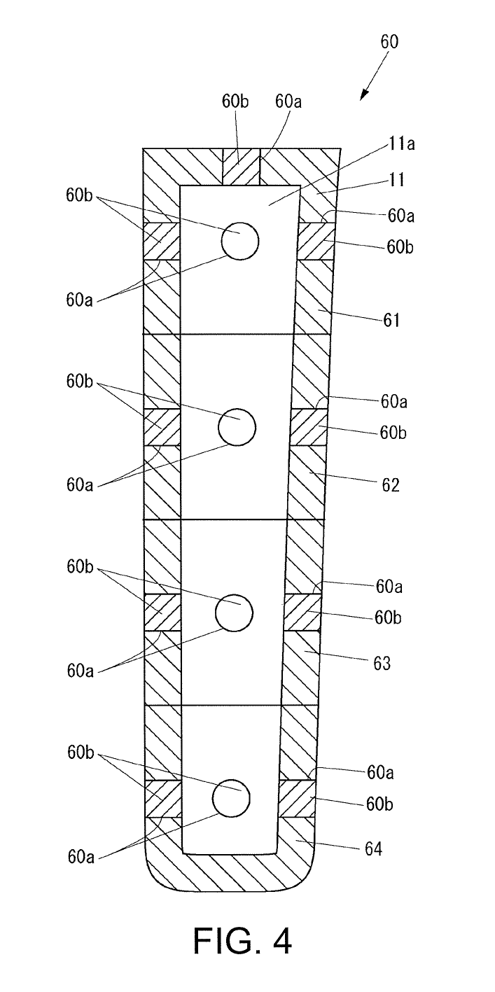

FIG. 4 is a front cross-sectional view of the shell portion 11 of the right leg portion 60.

As shown in FIG. 4, the shell portion 11 of the right leg portion 60 is formed with a plurality of holes 60a, and includes a lid 60b that closes each hole 60a. The hole 60a is used as a filling material introducing port for introducing the filling material 12 into the cavity 11a when filling the cavity 11a with the filling material 12 (see FIG. 2) and a gas discharging port for discharging the gas in the cavity 11a to outside the cavity 11a when filling the cavity 11a with the filling material 12.

The hole 60a is preferably formed in an area that is less likely to stand out in terms of design in the three-dimensional object 10.

The configurations of the body portion 20, the head portion 30, the right arm portion 40, the left aim portion 50, and the left leg portion 70 are also similar to the configuration of the right leg portion 60.

Next, a 3D data generation system for generating 3D data of the shell portion 11 of the three-dimensional object 10 will be described.

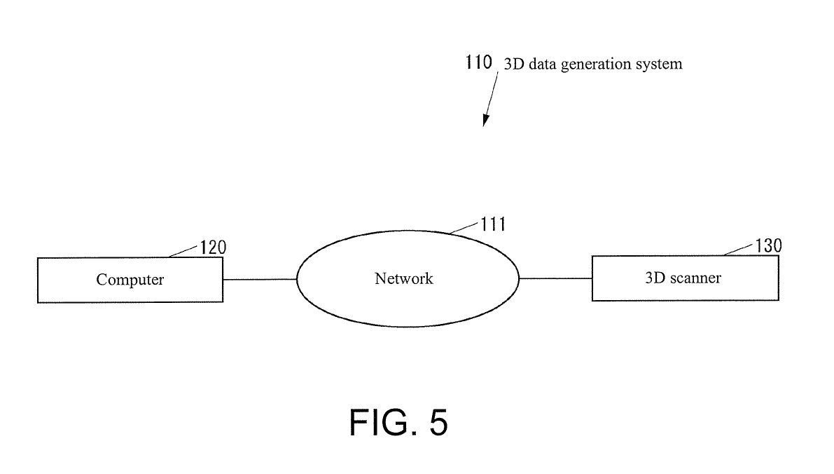

FIG. 5 is a block diagram of a 3D data generation system 110 for generating 3D data of the shell portion 11 of the three-dimensional object 10.

As shown in FIG. 5, the 3D data generation system 110 includes a computer 120 such as a PC (Personal Computer), and a 3D scanner 130 that acquires the 3D data of the actual object.

The computer 120 and the 3D scanner 130 can communicate with each other directly in a wired or wireless manner without through a network 111 such as the LAN (Local Area Network), and the Internet, or can communicate through the network 111.

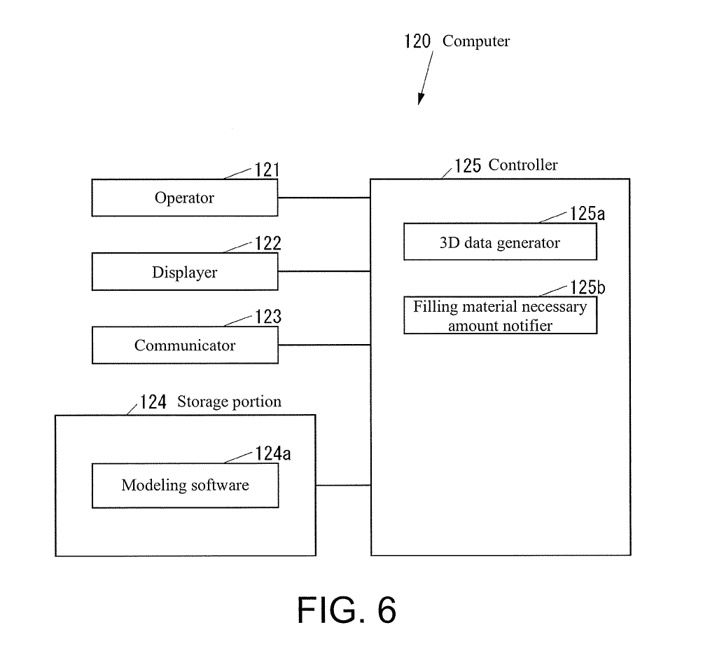

FIG. 6 is a block diagram of the computer 120.

As shown in FIG. 6, the computer 120 includes an operator 121, which is an input device, such as a mouse, and a keyboard to which various operations are input, a displayer 122, which is a display device, such as an LCD (Liquid Crystal Display) that displays various information, a communicator 123, which is a communication device that communicates with an external device directly in a wired or wireless manner without through the network 111 (see FIG. 5) or that communicates through the network 111, a storage portion 124, which is a nonvolatile storage device, such as a semiconductor memory, and HDD (Hard Disk Drive) that stores various types of information, and a controller 125 that controls the entire computer 120.

The storage portion 124 stores modeling software 124a serving as a 3D data generation program for generating the 3D data of the shell portion of the three-dimensional object. The modeling software 124a may be installed in the computer 120 at the manufacturing stage of the computer 120, may be additionally installed to the computer 120 from an external storage medium such as a USB (Universal Serial Bus) memory, a CD (Compact Disc), and a DVD (Digital Versatile Disc), or may be additionally installed to the computer 120 from the network 111.

The controller 125 includes, for example, a CPU (Central Processing Unit), a ROM (Read Only Memory) storing programs and various types of data, and a RAM (Random Access Memory) used as a work region of the CPU. The CPU executes the program stored in the ROM or the storage portion 124.

The controller 125 realizes a 3D data generator 125a that generates the 3D data of the shell portion and a filling material necessary amount notifier 125b that notifies the necessary amount of the filling material by executing the modeling software 124a.

Next, a 3D data generation method according to the present embodiment will be described.

The 3D data generator 125a generates the 3D data of the shell portion of the three-dimensional object according to the operation through the operator 121. The 3D data of the shell portion of the three-dimensional object may be processed from the 3D data acquired by 3D scanning the actual object with the 3D scanner 130.

The 3D data generator 125a can divide the shell portion of the three-dimensional object into a plurality of parts according to the operation through the operator 121.

The 3D data generator 125a can change the position, shape, and size of the cavity of the three-dimensional object according to the operation through the operator 121.

The 3D data generator 125a can change the position, shape, and size of the hole of the three-dimensional object according to the operation through the operator 121.

The 3D data generator 125a can specify an area where the filling material is not reached in the cavity when the filling material is introduced into the cavity from the hole serving as the filling material introducing port. For example, it is difficult for the filling material to pass the area where a flow path of the filling material is narrow or smaller than or equal to a specific area. Furthermore, at the area distant from the hole serving as the filling material introducing port, the filling material introduced into the cavity from the relevant hole is less likely to reach such an area.

When specifying an area where the filling material is not reached, the 3D data generator 125a may change the 3D data with the specified area as one part of the shell portion. In other words, the 3D data generator 125a may change the position, shape, and size of the cavity of the three-dimensional object so that the area where the filling material is not reached becomes a part of the shell portion.

Furthermore, when specifying the area where the filling material is not reached, the 3D data generator 125a may change the 3D data to a configuration of the filling material introducing port that allows the filling material to reach the specified area. In other words, the 3D data generator 125a may change the position, shape, and size of the hole of the three-dimensional object, or change the number of holes of the three-dimensional object so that the filling material reaches the area where the filling material is not reached.

Furthermore, when specifying the area where the filling material is not reached, the 3D data generator 125a may notify the specified area through the displayer 122. An operator (hereinafter referred to as “data generating person”) who generates the 3D data can change the position, shape, and size of the cavity of the three-dimensional object by inputting a specific operation to the operator 121 while taking the area notified through the displayer 122 into consideration. Furthermore, the data generating person can change the position, shape, and size of the hole of the three-dimensional object or change the number of holes of the three-dimensional object by inputting a specific operation to the operator 121 while taking the area notified from the 3D data generator 125a into consideration.

The filling material necessary amount notifier 125b calculates the necessary amount of the filling material based on the volume of the cavity of the three-dimensional object in the 3D data, and notifies the calculated necessary amount through the displayer 122. Therefore, the worker (hereinafter referred to as “filling worker”) who introduces the filling material into the cavity of the shell portion from the hole of the shell portion can prepare the filling material while taking the necessary amount notified from the filling material necessary amount notifier 125b into consideration.

Now, a manufacturing method of the shell portion 11 of the three-dimensional object 10 will now be described.

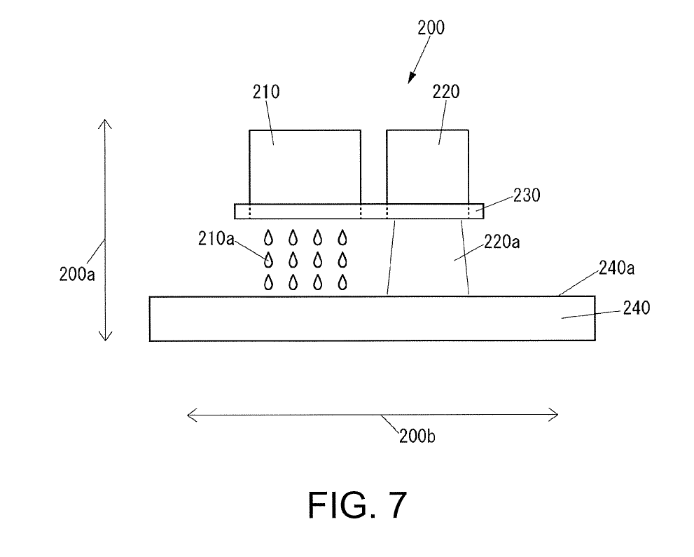

FIG. 7 is a front view of a 3D printer 200 for manufacturing the shell portion 11 of the three-dimensional object 10.

As shown in FIG. 7, the 3D printer 200 includes a carriage 230 mounted with a plurality of inkjet heads 210 that discharge an ultraviolet curing type ink (hereinafter referred to as “UV ink”) 210a toward the lower side in a vertical direction indicated with an arrow 200a, and an ultraviolet irradiating device 220 that irradiates the UV ink 210a discharged by the inkjet head 210 with the ultraviolet ray 220a.

In FIG. 7, only one inkjet head 210 is shown. Actually, however, the 3D printer 200 may, for example, include the inkjet head 210 for every type of UV ink 210a.

The UV ink 210a includes, for example, a shaping ink that becomes the material of the shell portion of the three-dimensional object, and a support ink that becomes the material of a support portion that supports the shell portion to form the shell portion of an arbitrary shape with the shaping ink. The shaping ink may include a color ink that forms a surface portion of the shell portion, and a white ink that forms the interior of the shell portion to develop color by the color ink. The support ink is, for example, an ink that can be easily removed with a specific liquid such as water. In the 3D printer 200, the support portion is formed on the lower side in the vertical direction and the horizontal direction with respect to the shell portion. For example, if the shell portion includes an overhang portion, the support portion is formed on the lower side in the vertical direction with respect to the overhang portion to support the overhang portion.

The 3D printer 200 includes a table 240 formed with a supporting surface 240a for supporting the shell portion and the support portion formed by the UV ink 210a discharged by the inkjet head 210 and cured by the ultraviolet ray 220a from the ultraviolet irradiating device 220.

The supporting surface 240a is extended in the horizontal direction indicated with an arrow 200b.

Either one of the carriage 230 and the table 240 is relatively movable in the horizontal direction with respect to the other one.

For example, the carriage 230 can relatively move in the main scanning direction with respect to the table 240 by being supported by a mechanism (not shown) so as to be movable in the main scanning direction in the horizontal direction. Hereinafter, an example in which the carriage 230 is relatively moved in the main scanning direction with respect to the table 240 by being moved in the main scanning direction will be described, but the table 240 may be relatively moved in the main scanning direction with respect to the carriage 230 by being moved in the main scanning direction, or either one of the carriage 230 and the table 240 may be relatively moved in the main scanning direction with respect to the other one when the carriage 230 and the table 240 are respectively moved in the main scanning direction.

Furthermore, the carriage 230 is relatively movable in the sub-scanning direction with respect to the table 240 by being supported by a mechanism (not shown) so as to be movable in the sub-scanning direction orthogonal to the main scanning direction in the horizontal direction. Hereinafter, an example in which the carriage 230 is relatively moved in the sub-scanning direction with respect to the table 240 by being moved in the sub-scanning direction will be described, but the table 240 may be relatively moved in the sub-scanning direction with respect to the carriage 230 by being moved in the sub-scanning direction, or either one of the carriage 230 and the table 240 may be relatively moved in the sub-scanning direction with respect to the other one when the carriage 230 and the table 240 are respectively moved in the sub-scanning direction.

Either one of the carriage 230 and the table 240 is relatively movable in the vertical direction with respect to the other one. For example, the table 240 is relatively movable in the vertical direction with respect to the carriage 230 by being supported by a mechanism (not shown) so as to be movable in the vertical direction. Hereinafter, an example in which the table 240 is relatively moved in the vertical direction with respect to the carriage 230 by being moved in the vertical direction will be described, but the carriage 230 may be relatively moved in the vertical direction with respect to the table 240 by being moved in the vertical direction, or either one of the carriage 230 and the table 240 may be relatively moved in the vertical direction with respect to the other one when the carriage 230 and the table 240 are respectively moved in the vertical direction.

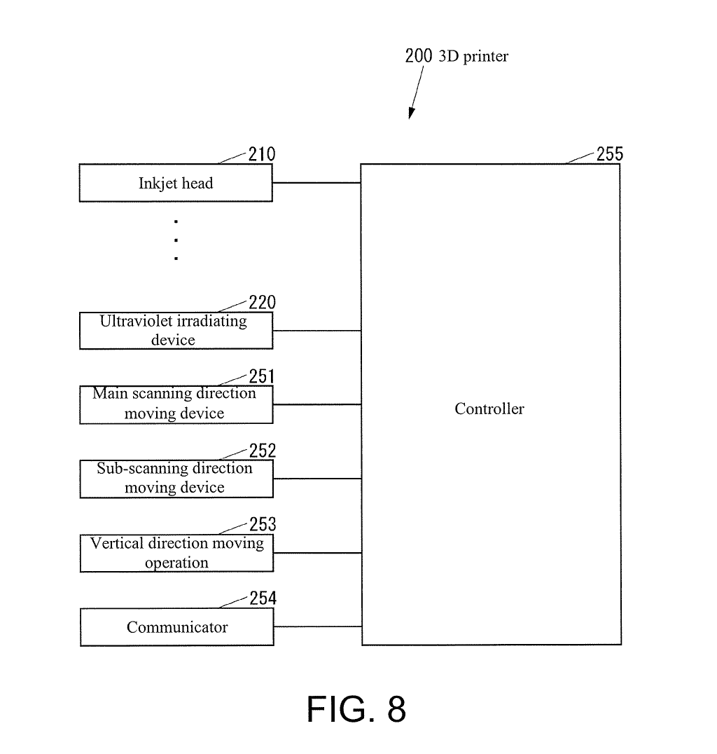

FIG. 8 is a block diagram of the 3D printer 200.

As shown in FIG. 8, the 3D printer 200 includes a main scanning direction moving device 251 that moves the carriage 230 in the main scanning direction, a sub-scanning direction moving device 252 that moves the carriage 230 in the sub-scanning direction, a vertical direction moving device 253 that moves the table 240 in the vertical direction, a communicator 254, which is a communication device, that communicates with an external device directly in a wired or wireless manner without through the network such as the LAN, or that communicates through the network, and a controller 255 that controls the entire 3D printer 200.

The controller 255 includes, for example, a CPU, a ROM storing programs and various types of data in advance, and a RAM used as a work region of the CPU. The CPU executes the program stored in the ROM.

The controller 255 controls the inkjet head 210, the ultraviolet irradiating device 220, the main scanning direction moving device 251, the sub-scanning direction moving device 252, and the vertical direction moving device 253 based on the 3D data input through the communicator 254. Specifically, the controller 255 forms a layer extending in the horizontal direction with the shaping ink and the support ink by means of the inkjet head 210 and the ultraviolet irradiating device 220 while moving the carriage 230 in the main scanning direction with the main scanning direction moving device 251 every time the position of the carriage 230 in the sub-scanning direction with respect to the table 240 is changed by the sub-scanning direction moving device 252. The controller 255 repeats the above described operations every time the position of the table 240 in the vertical direction with respect to the carriage 230 is changed by the vertical direction moving device 253 to layer the layer extending in the horizontal direction formed by the shaping ink and the support ink in the vertical direction and form the shell portion and the support portion on the table 240.

When the shell portion with the support portion is formed, the worker (hereinafter referred to as “shell portion manufacturer”) who manufactures the shell portion can obtain the shell portion by removing the support portion from the shell portion. At least one part of the hole used as the filling material introducing port and the gas discharging port may be used as a support material discharging port for discharging the support material from the cavity of the shell portion.

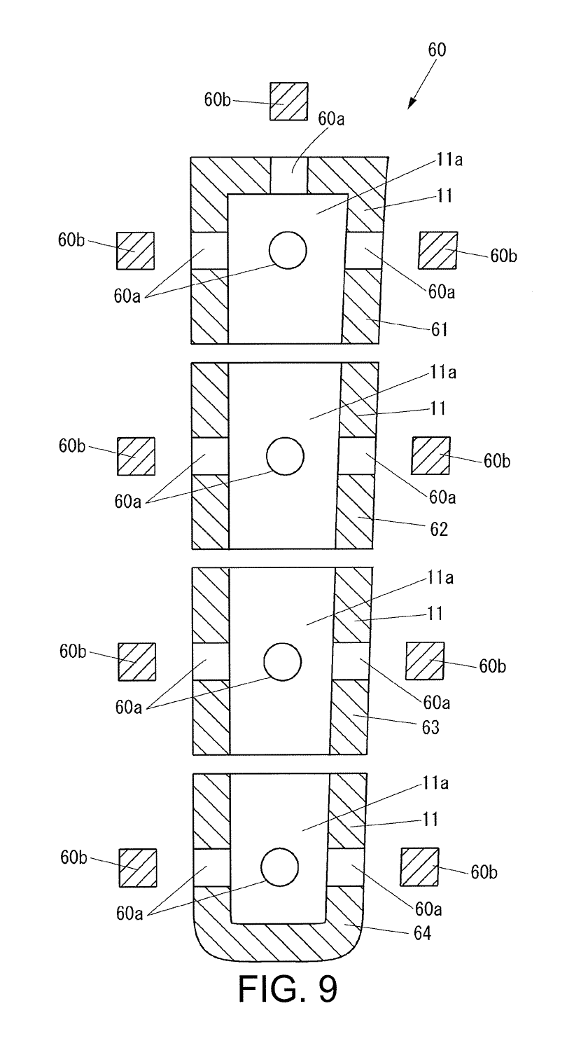

FIG. 9 is a front cross-sectional view of each part of the shell portion 11 of the right leg portion 60.

The shell portion manufacturer manufactures, for example, the parts of the shell portion 11 as shown in FIG. 9 through a three-dimensional printing by the 3D printer 200 as described above.

In FIG. 9, the parts of the shell portion 11 of the right leg portion 60 are shown, but it is similar for the parts of the shell portion 11 of the body portion 20, the head portion 30, the right arm portion 40, the left arm portion 50, and the left leg portion 70.

Next, a method for manufacturing the three-dimensional object will be described.

The parts of the shell portion 11 obtained through the three-dimensional printing by the 3D printer 200 as described above are conveyed to an installing area of the three-dimensional object.

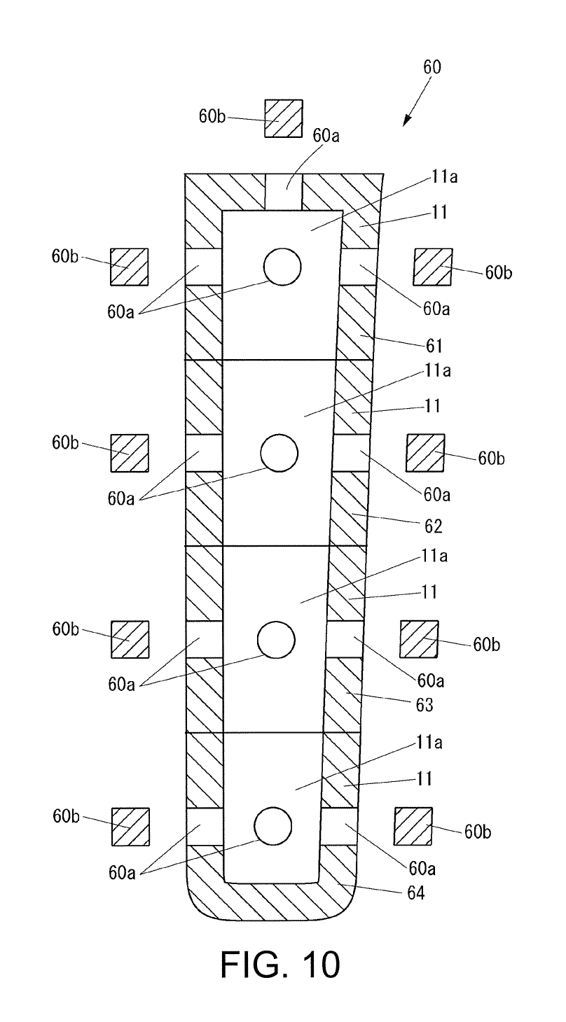

FIG. 10 is a front cross-sectional view of the shell portion 11 of the right leg portion 60 in a state where the parts are combined.

The worker (hereinafter referred to as “3D object manufacturer”) who manufactures the three-dimensional object assembles the shell portion 11 of the right leg portion 60 as shown in FIG. 10 by combining the parts of the shell portion 11 obtained through the three-dimensional printing by the 3D printer 200 as described above. The 3D object manufacturer assembles the shell portion 11 of the body portion 20, the head portion 30, the right arm portion 40, the left arm portion 50, and the left leg portion 70, similar to the shell portion 11 of the right leg portion 60.

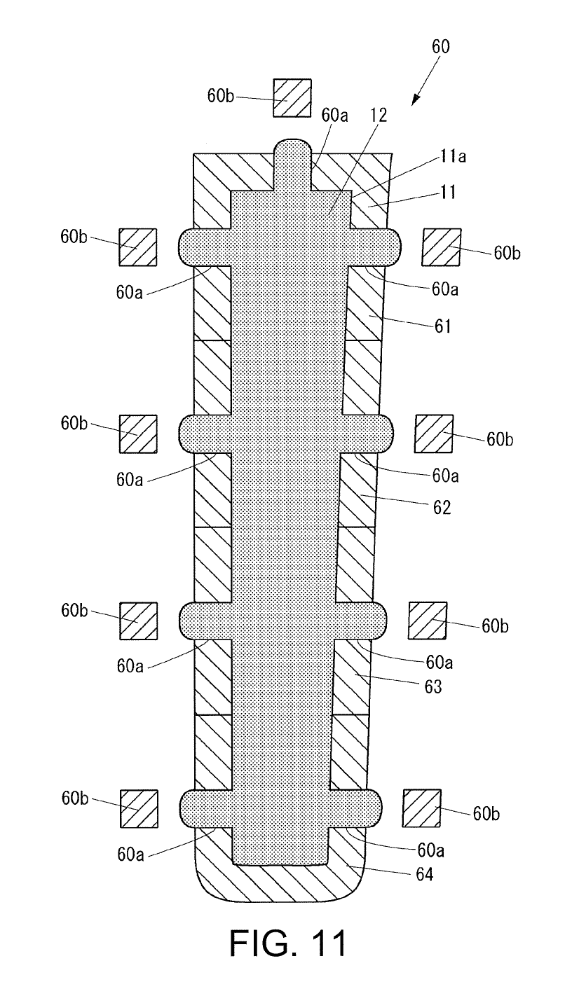

FIG. 11 is a front cross-sectional view of the shell portion 11 of the right leg portion 60 in a state where the filling material 12 is introduced into the cavity 11a.

The filling worker (3D object manufacturer) introduces the filling material 12 into the cavity 11a of the shell portion 11 from the hole 60a of the shell portion 11 of the right leg portion 60, as shown in FIG. 11, after the shell portion 11 of the right leg portion 60 is assembled. The 3D object manufacturer introduces the filling material 12 into the cavity 11a of the shell portion 11 from the hole of the shell portion 11 for the shell portion 11 of the body portion 20, the head portion 30, the right arm portion 40, the left arm portion 50, and the left leg portion 70, similar to the shell portion 11 of the right leg portion 60. When introduced into the cavity 11a of the shell portion 11 from the hole of the shell portion 11, the filling material 12 is foamed thus increasing the volume in the cavity 11a.

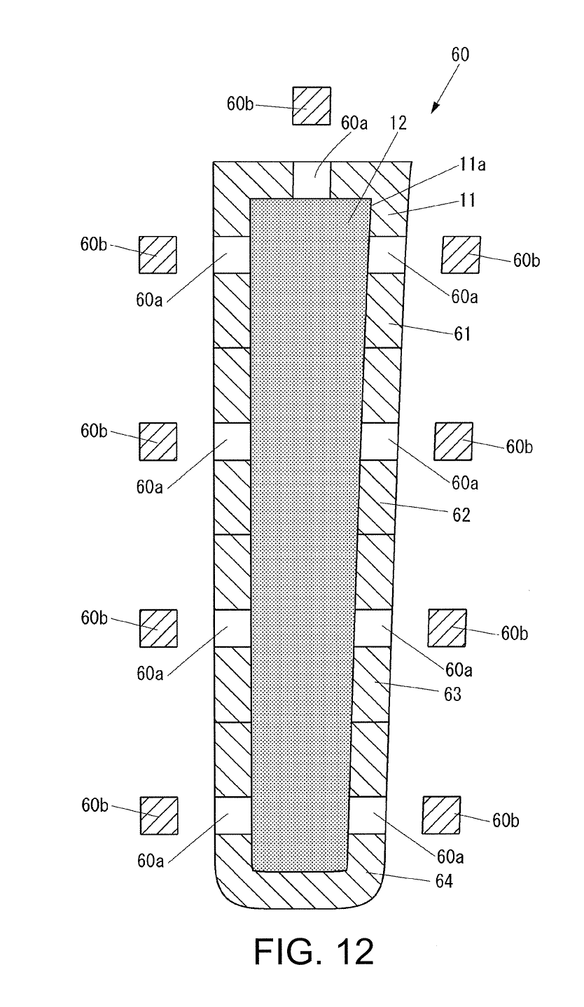

FIG. 12 is a front cross-sectional view of the right leg portion 60 before the lid 60b is attached.

After introducing the filling material 12 into the cavity 11a of the shell portion 11 from the hole 60a of the shell portion 11, the 3D object manufacturer removes the filling material 12 running out to the outside of the shell portion 11 from the hole 60a by cutting, and the like, as shown in FIG. 12. The 3D object manufacturer also removes the filling material 12 running out to the outside of the shell portion 11 from the hole for the body portion 20, the head portion 30, the right arm portion 40, the left arm portion 50, and the left leg portion 70, similar to the right leg portion 60.

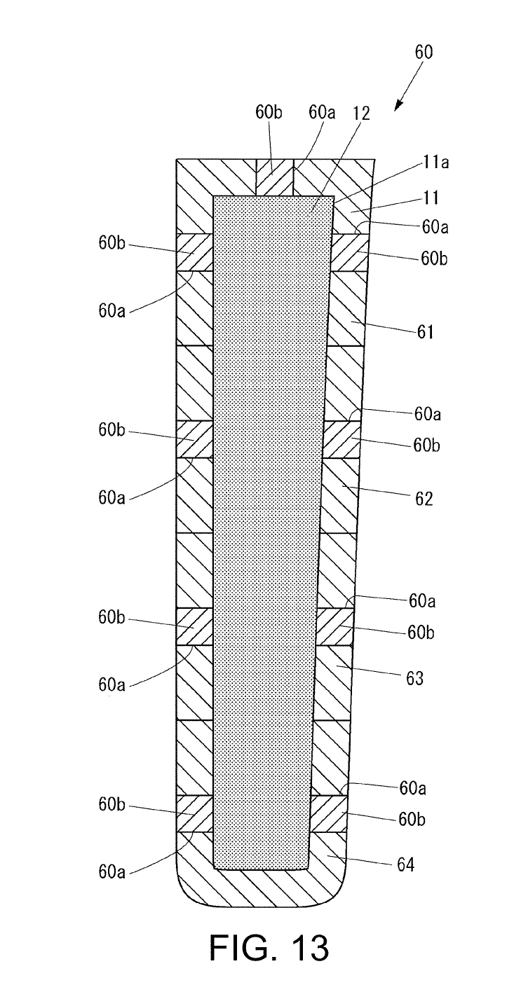

FIG. 13 is a front cross-sectional view of the right leg portion 60.

After removing the filling material 12 running out to the outside of the shell portion 11 from the hole 60a, the 3D object manufacturer attaches the lid 60b to the hole 60a as shown in FIG. 13 to complete the right leg portion 60. The 3D object manufacturer also attaches the lid to the hole to complete the body portion 20, the head portion 30, the right arm portion 40, the left arm portion 50, and the left leg portion 70, similar to the right leg portion 60.

Lastly, as shown in FIG. 2, the 3D object manufacturer combines the body portion 20, the head portion 30, the right arm portion 40, the left arm portion 50, the right leg portion 60, and the left leg portion 70 to complete the three-dimensional object 10.

The 3D object manufacturer can separate the three-dimensional object 10 into each part after installing. The 3D object manufacturer may convey and store each part in the separated state to the storage place, or may convey each part in the separated state to a new installing place and recombine the parts to install the three-dimensional object 10 at the new installing place.

As described above, the three-dimensional object 10 becomes lighter as the filling material 12, having smaller specific gravity than the shell portion 11, is filled into the cavity 11a of the shell portion 11, whereby handling when being conveyed and installed can be more facilitated than the conventional art even if the object is large.

The three-dimensional object 10 can be subdivided by being divided into a plurality of parts, and thus the handling when being conveyed and installed can be facilitated even if the object is large.

The three-dimensional object 10 may have a configuration that cannot be divided into a plurality of parts.

The three-dimensional object 10 can facilitate the handling when being conveyed and installed even if the object is large since the shell portion 11 is conveyed in a state where the filling material 12 is not filled into the cavity 11a of the shell portion 11, and after the shell portion 11 is conveyed, the filling material 12 is introduced into the cavity 11a of the shell portion 11 from the filling material introducing port of the shell portion 11.

The three-dimensional object 10 is formed with the gas discharging port for discharging the gas in the cavity 11a to the outside of the cavity 11a when filling the filling material 12 into the cavity 11a, and thus even if the filling material 12 is introduced into the cavity 11a of the shell portion 11 from the filling material introducing port of the shell portion 11, the pressure of the gas in the cavity 11a can be suppressed from increasing. Therefore, the three-dimensional object 10 can suppress deformation and breakage from occurring in the shell portion 11 by the increase in the pressure of the gas in the cavity 11a. The effect of suppressing the increase in the pressure of the gas in the cavity 11a is significant when the filling material 12 is a foamed type.

When the support material discharging port also acts as at least one of the filling material introducing port and the gas discharging port, the three-dimensional object 10 can simplify the configuration compared to the configuration in which the support material discharging port is provided separate from the filling material introducing port and the gas discharging port.

The computer 120 that executes the modeling software 124a notifies the necessary amount of the filling material 12 through the displayer 122, and thus the filling worker can prepare the appropriate amount of filling material 12 thus enhancing convenience.

The computer 120 that executes the modeling software 124a specifies the area where the filling material 12 does not reach in the cavity 11a when the filling material 12 is introduced into the cavity 11a from the filling material introducing port, and changes the 3D data with the specified area as one part of the shell portion or changes the 3D data to the configuration of the filling material introducing port that can allow the filling material to reach the specified area, so that the filling material 12 can spread throughout the entire cavity 11a when the filling material 12 is introduced into the cavity 11a from the filling material introducing port. In other words, the computer 120 can generate the 3D data of the shell portion 11 so that the filling material 12 can spread throughout the cavity 11a of the shell portion 11 when the filling material 12 is introduced into the cavity 11a of the shell portion 11 from the filling material introducing port. Therefore, the computer 120 can enhance the quality of the three-dimensional object 10 to be manufactured.

The three-dimensional object 10 is manufactured through the three-dimensional printing by the 3D printer 200 in the description made above, but may be manufactured through a method other than the three-dimensional printing by the 3D printer 200 such as, for example, FDM (Fused Deposition Modeling) method, powder method, and 3D photolithography (shaping by spot irradiating container filled with liquid with laser light).

Furthermore, the human model is an example of the three-dimensional object 10. The three-dimensional object according to the present embodiment may be various objects other than the human model.

What is claimed is:

1. A three-dimensional object, comprising:
a shell portion, internally formed with a cavity; and
a filling material that is filled in the cavity, the filling material having a smaller specific gravity than the shell portion.

2. The three-dimensional object according to claim 1, wherein
the shell portion is configured by a plurality of parts.

3. The three-dimensional object according to claim 1, wherein
the shell portion is formed with a filling material introducing port for introducing the filling material into the cavity when filling the filling material into the cavity, and a gas discharging port, for discharging gas in the cavity to outside the cavity when filling the filling material into the cavity.

4. The three-dimensional object according to claim 3, wherein
the shell portion is formed with a support material discharging port for discharging a support material that supports at least one part of the shell portion from the cavity when the shell portion is shaped, and
the support material discharging port is at least one of the filling material introducing port and the gas discharging port.

5. A three-dimensional object manufacturing method for manufacturing the three-dimensional object according to claim 3, wherein
the shell portion is conveyed in a state where the filling material is not filled in the cavity, and
after the shell portion is conveyed, the filling material is introduced into the cavity from the filling material introducing port.

6. A three-dimensional object manufacturing method for manufacturing the three-dimensional object according to claim 4, wherein
the shell portion is conveyed in a state where the filling material is not filled in the cavity, and
after the shell portion is conveyed, the filling material is introduced into the cavity from the filling material introducing port.

7. A non-transitory computer readable medium stored with a 3D data generation program for generating 3D data of the shell portion of the three-dimensional object according to claim 1, wherein
the 3D data generation program causes a computer to realize a 3D data generator for generating the 3D data of the shell portion, and a filling material necessary amount notifier for notifying a necessary amount of the filling material, and
the filling material necessary amount notifier calculates the necessary amount of the filling material based on a volume of the cavity.

8. A non-transitory computer readable medium stored with a 3D data generation program for generating 3D data of the shell portion of the three-dimensional object according to claim 2, wherein
the 3D data generation program causes a computer to realize a 3D data generator for generating the 3D data of the shell portion, and a filling material necessary amount notifier for notifying a necessary amount of the filling material, and
the filling material necessary amount notifier calculates the necessary amount of the filling material based on a volume of the cavity.

9. A non-transitory computer readable medium stored with a 3D data generation program for generating 3D data of the shell portion of the three-dimensional object according to claim 3, wherein
the 3D data generation program causes a computer to realize a 3D data generator for generating the 3D data of the shell portion, and a filling material necessary amount notifier for notifying a necessary amount of the filling material, and
the filling material necessary amount notifier calculates the necessary amount of the filling material based on a volume of the cavity.

10. A non-transitory computer readable medium stored with a 3D data generation program for generating 3D data of the shell portion of the three-dimensional object according to claim 4, wherein
the 3D data generation program causes a computer to realize a 3D data generator for generating the 3D data of the shell portion, and a filling material necessary amount notifier for notifying a necessary amount of the filling material, and
the filling material necessary amount notifier calculates the necessary amount of the filling material based on a volume of the cavity.

11. A non-transitory computer readable medium stored with a 3D data generation program for generating 3D data of the shell portion of the three-dimensional object according to claim 3, wherein
the 3D data generation program causes a computer to realize a 3D data generator for generating the 3D data, and
the 3D data generator specifies an area where the filling material is not reached in the cavity when the filling material is introduced into the cavity from the filling material introducing port, and changes the 3D data with the area which is specified as one part of the shell portion.

12. A non-transitory computer readable medium stored with a 3D data generation program for generating 3D data of the shell portion of the three-dimensional object according to claim 4, wherein
the 3D data generation program causes a computer to realize a 3D data generator for generating the 3D data, and
the 3D data generator specifies an area where the filling material is not reached in the cavity when the filling material is introduced into the cavity from the filling material introducing port, and changes the 3D data with the area which is specified as one part of the shell portion.

13. A non-transitory computer readable medium stored with a 3D data generation program for generating 3D data of the shell portion of the three-dimensional object according to claim 3, wherein
the 3D data generation program causes a computer to realize a 3D data generator for generating the 3D data, and
the 3D data generator specifies an area where the filling material is not reached in the cavity when the filling material is introduced into the cavity from the filling material introducing port, and changes the 3D data to a configuration of the filling material introducing port that allows the filling material to reach the area which is specified.

14. A non-transitory computer readable medium stored with a 3D data generation program for generating 3D data of the shell portion of the three-dimensional object according to claim 4, wherein
the 3D data generation program causes a computer to realize a 3D data generator for generating the 3D data, and
the 3D data generator specifies an area where the filling material is not reached in the cavity when the filling material is introduced into the cavity from the filling material introducing port, and changes the 3D data to a configuration of the filling material introducing port that allows the filling material to reach the area which is specified.
